(19) United States
(12) Patent Application Publication
(10) Pub. No.: US 2004/0013231 A1
(43) Pub. Date: Jan. 22, 2004

(54) Diffraction system for biological crystal screening

(76) Inventors: Bob Baoping He, Madison, WI (US); Roger D. Durst, Middleton, WI (US)

Correspondence Address: KUDIRKA & JOBSE, LLP, ONE STATE STREET, SUITE 800, BOSTON, MA, 02109, US

(21) Appl. No.: 09/896,824

(22) Filed: Jun. 29, 2001

(51) Int. Cl. G01N 23/20

(52) U.S. Cl. 378/73; 378/71

(57) ABSTRACT

A biological crystal formation screening apparatus uses an x-ray diffraction technique to analyze the sample containers of a sample tray for the presence of crystal formation. An x-ray source is directed toward a sample under investigation, and a two-dimensional x-ray detector is located to receive any diffracted x-ray energy. A positioning apparatus allows the different sample containers of a tray to be sequentially aligned with the source and detector, allowing each to be examined. Various techniques for interpreting the detector output data are also provided.

### FIELD OF THE INVENTION

The present invention relates generally to the field of structural genomics and, more specifically, to the use of crystallography to examine protein crystals for genomic research.

### BACKGROUND OF THE INVENTION

In biological research, particularly in the field of genomics, crystallography is a tool used to examine the characteristics of proteins. However, such proteins are typically developed in a liquid medium, and therefore must be crystallized in an orderly fashion before detailed crystallography techniques may be used. A typical method for crystallizing such proteins is through vapor diffusion. In a method known as the “hanging drop” method, a well solution is placed in the many separate sample wells of the sample tray. For each sample well, a drop of protein liquid is applied to a slide, which is placed over the sample well with the drop hanging down toward the well solution. Because of different relative concentrations of the well solution and the droplet solution, over time, liquid diffuses out of the droplet and into the sample well, resulting in the crystallization of the protein on the surface of the slide.

Depending on the conditions under which the crystallization process takes place, the formation of a crystal may take anywhere from hours to months. While some crystals are visible to the naked eye, the sample slides must usually be examined with a microscope one at a time to determine whether protein crystallization has taken place. Of course, for those protein samples that have not yet crystallized, the slides must be reexamined on a regular basis until the crystallization is observed. For a relatively large number of samples, this is obviously a long and labor-intensive process.

### SUMMARY OF THE INVENTION

In accordance with the present invention, a screening apparatus is provided for monitoring crystal formation in a crystal growth medium that makes use of an x-ray source and detector. X-ray energy from the x-ray source is incident on a sample container and undergoes diffraction if in the presence of a crystal structure. Any such diffracted x-ray energy is detected by the x-ray detector, the output of which is indicative of the presence or absence of such a crystal structure. In this way, one may determine whether any significant crystal formation has taken place in the crystal growth medium, without the need for visual examination of the sample container. This is particularly useful for the examination of biological crystal formation common in genomics research.

In a preferred embodiment, the screening apparatus also includes a positioning apparatus for locating the sample container relative to the x-ray source and x-ray detector. The positioning apparatus has a support that is remotely movable in at least two dimensions, allowing the precise positioning of the sample container relative to the x-ray source and detector. This is particularly useful in the preferred embodiment of the invention, in which the sample container is one of a plurality of sample containers each having a separate crystal growing medium. The sample containers may be part of a contiguous array, such as in a sample tray having an array of sample wells. In such a case, the positioning apparatus may be used to move the sample containers so as to position them sequentially relative to the x-ray source and detector, thereby allowing sequential examination of the sample containers. In addition, the source and detector may be arranged to operate in reflective mode or in transmission mode. If used in transmission mode, the positioning apparatus preferably has an open section located between the source and a sample well under investigation so as to not interfere with the source x-ray energy.

The x-ray source and detector may be arranged such that the exposure of x-rays from the source covers a two-dimensional area of the sample container being examined, in particular, an area over which any significant crystal formation would be expected to appear. The detector, similarly, is a two-dimensional detector, providing simultaneous detection of x-ray energy diffracted from a similar two-dimensional region of the sample container. Therefore, a simultaneous set of pixel intensities may be collected that is indicative of any presence of crystal structures across the two-dimensional area of the sample container under investigation.

A control apparatus is preferably used to control the various aspects of the screening apparatus, including the triggering of the x-ray source and the collection and processing of data from the detector. The control apparatus may also be used to control the positioning apparatus to synchronize the alignment of the various sample containers in an array with the operation of the x-ray source and detector. In this way, a the system may be used to automatically analyze the entire array of sample containers to determine which, if any, show the formation of any significant crystal structure.

In addition to the structural aspects of the invention, various techniques are also provided that may be used to evaluate the intensity data from the pixels of the detector to make a determination of whether or not a crystal is present. One such technique involves determining the number of pixels having an intensity level exceeding a minimum pixel intensity level and comparing that number to a predetermined minimum number selected as being indicative of the presence of said crystal structure. In another method, the outputs from a predetermined number of pixels having the highest intensity levels are averaged and compared to an overall average intensity value of all the pixels. In yet another method, the pixel intensity values that are indicative of the presence of a crystal peak in the detected spectrum are isolated and integrated. This integrated crystal peak intensity is then compared to an integrated intensity of all the detector pixels.

### BRIEF DESCRIPTION OF THE DRAWINGS

The above and further advantages of the invention may be better understood by referring to the following description in conjunction with the accompanying drawings in which:

FIG. 1 is a schematic side view of a screening apparatus according to the present invention;

FIG. 2 is a graphical view of a two-dimensional set of x-ray intensities resulting from x-ray scattering from an amorphous surface;

FIG. 3 is a graphical view of a two-dimensional set of x-ray intensities resulting from diffraction from a crystal structure and background scattering from amorphous materials;

FIG. 4 is a schematic top view of a sample tray having an array of sample wells;

FIG. 5 is a graphical view of an absolute pixel intensity method of determining the presence of a crystal structure from a two-dimensional set of intensity data produced with a screening apparatus according to the present invention;

FIG. 6 is a graphical view of an relative pixel intensity method of determining the presence of a crystal structure from a two-dimensional set of intensity data produced with a screening apparatus according to the present invention; and

FIG. 7 is a schematic view of an alternative embodiment of the invention in which transmission mode x-ray diffraction is used with a sitting drop sample well arrangement.

### DETAILED DESCRIPTION

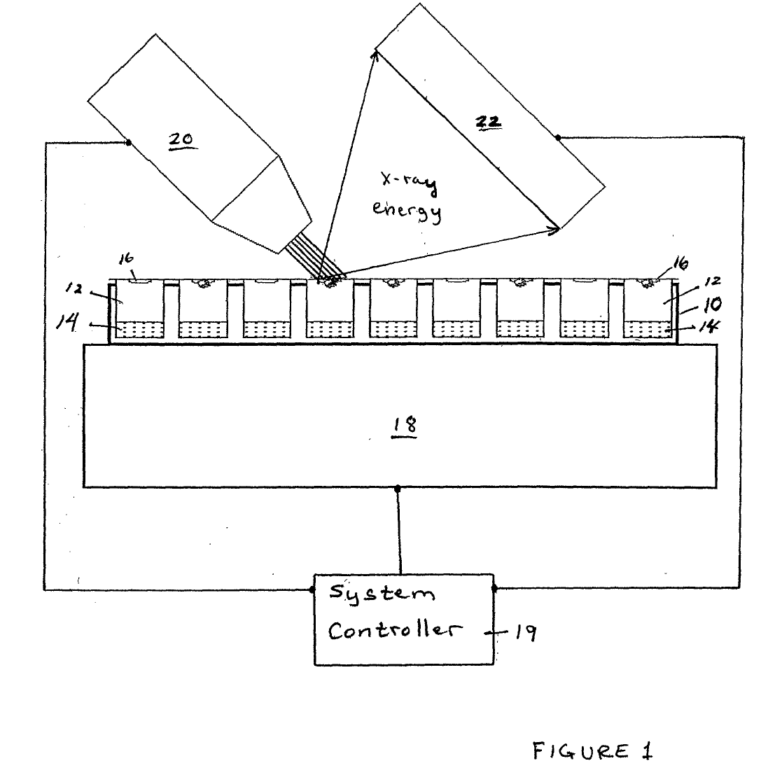

Shown in FIG. 1 is an x-ray screening apparatus that may be used to identify the crystallization of protein samples in a sample tray 10. In the figure, the sample tray 10 is shown in a cross-sectional side view, so that the contents of one row of sample wells 12 are apparent. Contained within each of the wells 12 is a well solution 14 that induces vapor diffusion from a sample drop located in the underside of a slide (or mylar film) 16 covering the top of the well. The process of vapor diffusion is well known in the art, and will not be repeated in any significant detail herein. However, in the present embodiment, rather than use visual inspection to determine when crystallization has occurred, the samples are examined using a diffraction-based technique.

In the embodiment of FIG. 1, the sample tray is mounted on a translation table 18 that is adjustable in three dimensions. The translation table allows the sample tray to be repositioned within a three dimensional area in order to align and realign the sample wells as desired. Control of the movement of the translation table 18 is preferably automated, and responsive to a control program for examining the samples. Movement of the translation table 18, and thereby the sample tray 10, allows it to be repositioned relative to x-ray source 20 and two-dimensional x-ray detector 22.

In the preferred embodiment, x-ray source 20 is a sealed tube or a rotating target generator that produces x-ray radiation in a wavelength range of approximately 0.5 to 2.3 angstrom. The source 20 also includes appropriate x-ray optics to condition the x-ray beam into a specified beam size, spectrum and beam profile. The detector 22 is any of a number of known two-dimensional x-ray detectors that can simultaneously detect the intensity of x-ray energy with a number of pixels across a two-dimensional area. In operation, each sample well is scanned one at a time. The scanning operation is controlled by a system controller 19 that controls the firing of the x-ray source 20, the data collection from detector 22 and movement of translation table 18. Preferably, the controller runs an automatic scanning routine that provides sequential scanning of all (or selected) sample wells, and corresponding data collection and processing. Control apparatus such as these are known in other fields, and are easily adaptable to the present invention by one skilled in the art. In operation, the translation table 18 moves the tray so that a sample well 12 to be examined is in the path of an x-ray beam from the source 20. The incident x-rays pass through the coverslips or mylar film and are incident upon the hanging droplet within the sample well. The cross-sectional area of the incident beam is large enough that a single exposure will reach any part of the well in which a crystal might form. If a crystal is present, it diffracts the x-rays from source 20 in the direction of the detector 22, where x-ray intensities are detected across the detector surface.

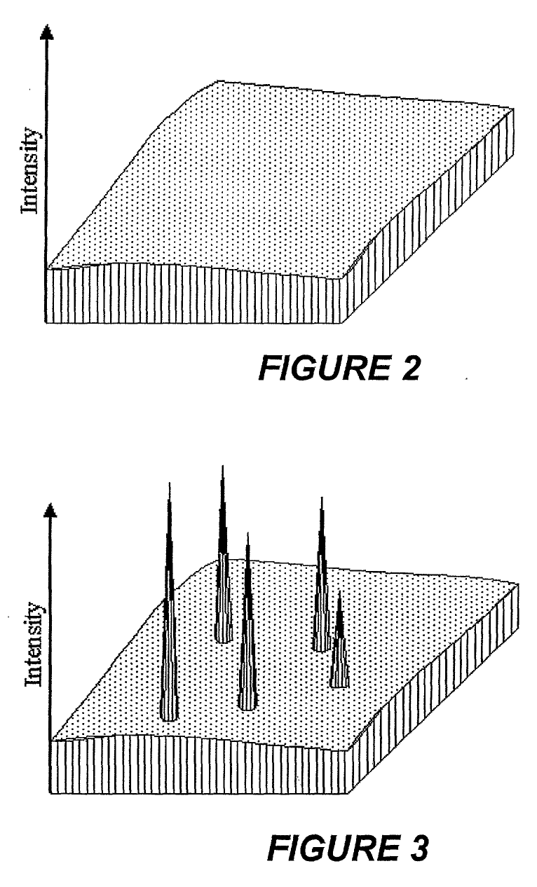

As each sample well is scanned, a data frame is collected for it that is representative of two-dimensional distribution of x-ray intensities across the detector surface. Based on the content of this data frame, a determination may be made regarding the degree to which any crystal structure has formed in the sample well under investigation. Shown in FIG. 2 is a graphical depiction of the pixel intensity distribution in a data frame for which there is no significant crystal formation. Materials surrounding the sample material, such as the crystallization plate, coverslips or mylar film and the liquid are amorphous, so that the x-rays scattered by them are randomly distributed. This results in a spectrum as shown in FIG. 2, in which there is a relatively consistent distribution of x-ray energy across the two-dimensional space.

When there is a significant degree of crystallization in a sample well, the crystal will diffract x-rays toward the detector 22. The diffracted x-rays form sharp intensity peaks much more intense than the background caused by scattering from amorphous materials. The particular crystallinity condition within each screening spot can be determined by the number and intensity of the peaks. An example of such a spectrum is depicted graphically in FIG. 3. As shown, within the background noise caused by the scattering from amorphous materials are several distinct diffraction peaks. The presence of these peaks may be used as part of an automated analysis program for screening the protein samples.

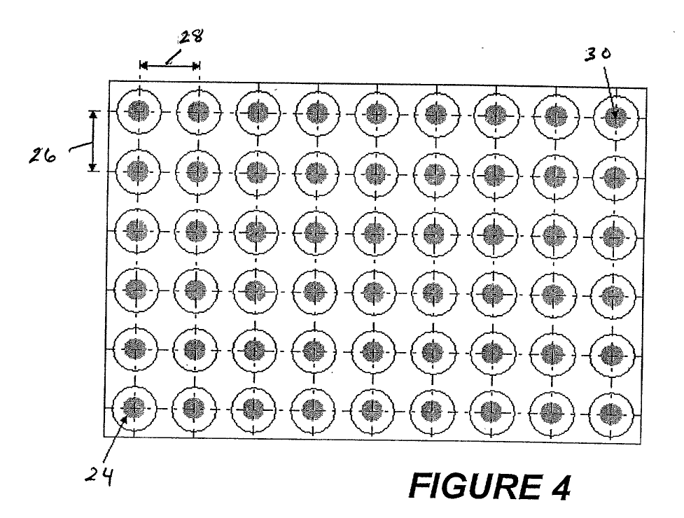

Shown in FIG. 4 is a schematic top view of a sample tray having a 6×9 array of sample wells. Those skilled in the art will recognize that this particular number of sample wells is for illustrative purposes only, and the actual sample tray may have any number of sample wells, and will likely have many more than are shown. From this figure, it may be understood that the translation table 18 shown in FIG. 1 may be used to move the sample so as to sequentially align the sample wells with the x-rays from source 20. The instrument center is defined by the crossing point of the incident x-ray beam and a center line of the detector. The system automatically and sequentially moves the tray so that the location of each droplet is sequentially moved to the instrument center. As each of the sample wells is aligned with the source, a data set is collected with the detector 22, and stored for analysis purposes. Using an arrangement as shown in FIG. 4, the progress in the movement of the tray may be broken down by a series of steps in two dimensions. Once the tray is located relative to a starting location, such as point 24, oriented at the instrument center, subsequent movements of the tray may be a series of predetermined steps, such as an x-dimension step 26, or a y-dimension step 28. With each step, a scan is performed of the sample well located at the new location, and the movement continues until an end location, such as location 30, is reached. At this point data collection is complete. Of course, those skilled in the art will recognize that any desired scanning pattern may be used as necessary, and the provision of a user interface that allows custom table movement is fully anticipated.

Once the desired droplet scan data is collected, it must be analyzed to determine a degree of crystallization in each of the sample wells being examined. The scanning portion of the invention may be used with any desired data analysis techniques. However, several possible techniques are disclosed herein.

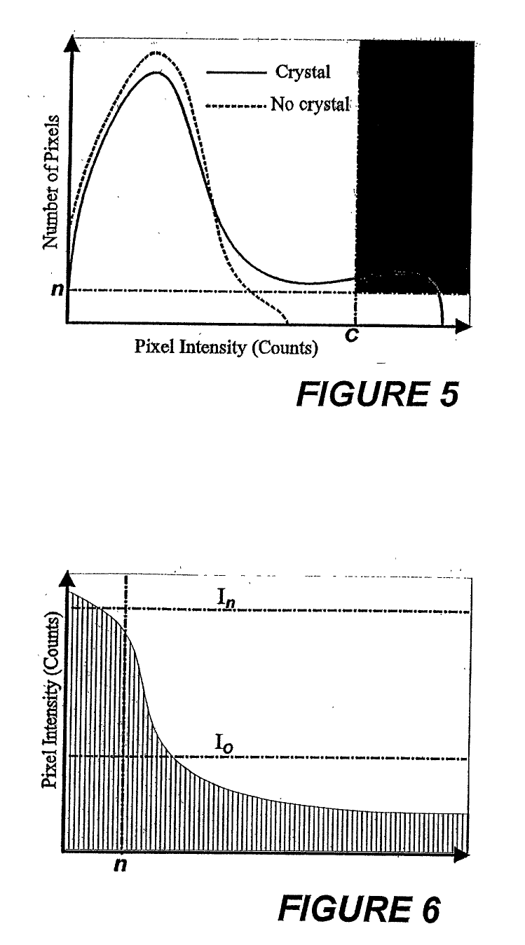

A first method of crystal peak identification may be referred to as the “absolute pixel intensity” method. The two-dimensional detector 22 has a given number of detection pixels, each of which detects a particular x-ray intensity each time a sample well is scanned. If pixel intensity is identified by a finite number of intensity levels, called “pixel counts,” than a data set may be collected that correlates each pixel with a corresponding pixel count. A determination of crystal presence may then be based on meeting a threshold number of pixels having a minimum intensity level. That is, the presence of a crystal will be assumed if at least a minimum number of pixels n have at least a minimum pixel count c. A graphical interpretation of this method is depicted in FIG. 5. In this figure, the horizontal axis represents pixel count while the vertical axis represents a number of pixels for a corresponding pixel count. The dashed line in the figure depicts the outcome if no crystal peaks are detected. As shown, none of the pixels register the minimum pixel count c, and a determination is therefore made that no significant crystallization has occurred at this droplet site. The solid line in the figure depicts the outcome when a sufficient number of crystal peaks are detected. As shown, the resulting curve includes more than n pixels with a minimum pixel count of c, and so a determination is made that sufficient crystallization has occurred at this site.

Another method of identifying crystal formation may be referred to as the “Relative Pixel Intensity” method. It relies on measuring the intensity of the brightest pixels relative to the average pixel intensity. In this embodiment, a predetermined number n of pixels are selected for having the highest intensity, and the average intensity Iₙ of these n pixels is compared to the average intensity Iₒ of all the pixels. If the ratio of the intensity of the high intensity pixels to the average pixel intensity is at least a predetermined value k, than sufficient crystallization is deemed to have occurred. The corresponding conditions may therefore be represented as follows:

If Iₙ/Iₒ≧k, crystal is found

If Iₙ/Iₒ<k, no crystal is found

The graphical representation of FIG. 6 shows the relative difference between the intensity averages Iₙ and Iₒ in a depiction of the pixel intensities arranged from highest to lowest along the horizontal axis.

Yet another method of determining the presence of crystallization may be referred to as “integrated peak intensity.” This method recognizes that, when crystallization is present, there is a wide intensity difference between the sharp peaks resulting from the crystal diffraction, and the background intensity due to amorphous scattering. Certain known mathematical models are available by which the pixel data from the diffraction peaks may be separated from the pixel data from the background. Once separated, the integrated intensities for all of the crystal peaks may be compared to the total integrated intensity in the data frame. If a ratio of the integrated intensity (I_{c}) of the crystal peaks to the integrated intensity of the entire data frame (Iₜ) exceeds a predetermined value p, then sufficient crystallization is deemed to have occurred. This relationship may therefore be represented as follows:

If I_{c}/Iₜ≧p, crystal is found

If I_{c}/Iₜ<p, no crystal is found

Those skilled in the art will recognize that many different criteria may be used to determine the presence of sufficient crystallization once the data from the detector pixels is collected. The particular method of determination may be customized to the systems and experiments of particular users.

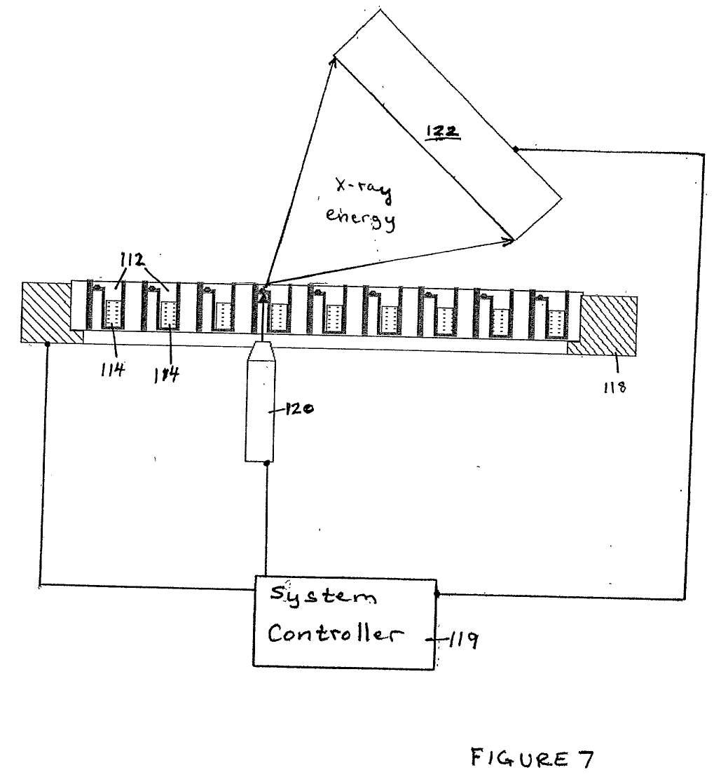

While the embodiment of FIG. 1 demonstrates the use of the screening technique of the present invention using a system in “reflection mode,” it is also possible to use a “transmission mode” arrangement. Such an arrangement is shown schematically in FIG. 7. Also demonstrated in this figure is the use of the present invention with the “sitting drop” type of vapor diffusion. Whereas the “hanging drop” method has the sample solution droplet positioned on the underside of a slide or other covering over the sample well, the “sitting drop” method locates the droplet on a separate platform elevated above the well solution 114. However, it should be noted that the present invention may be used in either reflection mode or transmission mode with either of the hanging drop or sitting drop arrangements.

In the embodiment of FIG. 7, an x-ray source 120 is located to the opposite side of the sample tray from a detector 122. At least the relevant portions of the sample tray are amorphous and effectively transparent to x-ray energy so that the x-ray energy from source 120 interacts with the protein sample in the well under investigation. The translation table 118 shown in the embodiment of FIG. 7 has a cutaway portion beneath the sample wells, and the sample tray is supported along its edges. This avoids the obstruction of the source 120 by the translation table. However, those skilled in the art will recognize that a different translation table could be used as long as only x-ray transparent material separated the source 120 and the wells 112.

When there is a significant degree of crystallization in a sample well 112, the crystal will diffract x-rays toward the detector 122. The diffracted x-rays form sharp intensity peaks much more intense than the background caused by scattering from amorphous materials. This diffraction spectrum is similar to that developed when using the invention in reflection mode, but the relative diffraction angles for the wavelengths being detected are obviously different in the two arrangements. In each case, the detected wavelength peaks will depend on the relative orientation of the components, the material under investigation and the x-ray wavelengths from the source 120. As in the embodiment of FIG. 1, it is preferred that the functions of the system, including operation of the x-ray source, movement of the translation table, and collection and processing of data from the detector 122 are coordinated by a system controller 119. Naturally, other uses of the present invention that vary from the embodiments shown are anticipated.

While the invention has been shown and described with reference to a preferred embodiment thereof, those skilled in the art will recognize that various changes in form and detail may be made herein without departing from the spirit and scope of the invention as defined by the appended claims.

What is claimed is:

1. A screening apparatus for use in monitoring crystal formation in a crystal growth medium within a sample container, the apparatus comprising:
an x-ray source that outputs x-ray energy that is incident on the sample and that undergoes diffraction in the presence of a crystal structure in the sample container; and
an x-ray detector that receives x-ray energy diffracted from said crystal structure and provides a signal indicative of the presence of the crystal structure in the sample container.

2. A screening apparatus according to claim 1 further comprising a positioning apparatus for positioning the sample container relative to the x-ray source and the x-ray detector.

3. A screening apparatus according to claim 2 wherein the positioning apparatus comprises a support that is remotely movable in at least two dimensions.

4. A screening apparatus according to claim 2 wherein the sample container is a first sample container and wherein the apparatus is arranged to operate on a plurality of sample containers each representing a separate crystal growing medium.

5. A screening apparatus according to claim 4 wherein the sample containers are all part of a contiguous sample array and wherein the positioning apparatus is capable of moving the sample array so as to sequentially position the sample containers relative to the x-ray source and x-ray detector to allow sequential examination of the sample containers.

6. A screening apparatus according to claim 1 wherein the crystal growth medium comprises a biological sample.

7. A screening apparatus according to claim 1 wherein the crystal growth medium comprises a vapor diffusion chamber.

8. A screening apparatus according to claim 1 wherein the x-ray detector is a two-dimensional detector.

9. A screening apparatus according to claim 8 wherein the x-ray source and x-ray detector are positioned such as to provide simultaneous exposure and detection across a two-dimensional area of the sample container.

10. A screening apparatus according to claim 1 further comprising a control apparatus that controls exposure of the sample container by the x-ray source and a collection of data from the x-ray detector.

11. A screening apparatus according to claim 10 wherein the apparatus further comprises a positioning apparatus for positioning the sample container relative to the x-ray source and the x-ray detector, and wherein the movement of the sample container with the positioning apparatus is controlled by the control apparatus.

12. A screening apparatus according to claim 1 wherein the x-ray source and detector operate in reflection mode.

13. A screening apparatus according to claim 1 wherein the x-ray source and detector operate in transmission mode.

14. A screening apparatus according to claim 1 further comprising a positioning apparatus for positioning the sample container relative to the x-ray source and the x-ray detector, the positioning apparatus being arranged such that no obstruction exists between the x-ray source and the sample container.

15. A screening apparatus for use in monitoring crystal formation in a biological crystal growth medium within a sample container, the apparatus comprising:
an x-ray source that outputs x-ray energy that is incident across an area of the sample container and that undergoes diffraction in the presence of a crystal structure in the sample container;
a two-dimensional x-ray detector that receives x-ray energy diffracted from said crystal structure and outputs a signal indicative of the presence of the crystal structure in the sample container; and
a positioning apparatus for positioning the sample container relative to the x-ray source and the x-ray detector, the positioning apparatus comprising a support that is movable in at least two dimensions.

16. A screening apparatus according to claim 15 wherein the sample container is a first sample container and wherein the apparatus is arranged to operate on a plurality of sample containers each representing a separate growing medium, the sample containers being part of a contiguous sample array, and wherein the positioning apparatus is capable of moving the sample array so as to sequentially position the sample containers relative to the x-ray source and x-ray detector to allow sequential examination of the sample containers.

17. A screening apparatus according to claim 15 wherein the crystal growth medium comprises a vapor diffusion chamber.

18. A screening apparatus according to claim 15 further comprising a control apparatus that controls exposure of the sample container by the x-ray source and a collection of data from the x-ray detector and that controls the positioning apparatus for positioning the sample container relative to the x-ray source and the x-ray detector.

19. A method of monitoring crystal formation in a crystal growth medium within a sample container, the method comprising:
directing x-ray energy at the sample with an x-ray source such that the x-ray energy is incident on the sample and undergoes diffraction in the presence of a crystal structure in the sample container; and
receiving x-ray energy diffracted from the crystal structure with an x-ray detector and providing a signal indicative of the presence of the crystal structure in the sample container.

20. A method according to claim 19 further comprising positioning the sample container relative to the x-ray source and the x-ray detector with a positioning apparatus.

21. A method according to claim 20 wherein the positioning apparatus comprises a support that is remotely movable in at least two dimensions.

22. A method according to claim 20 wherein the sample container is a first sample container and wherein the method further comprises sequentially directing x-rays at each of a plurality of sample containers each representing a separate crystal growing medium, receiving any diffracted x-ray energy from each sample container and providing a signal indicative of the presence any crystal structures in the sample containers.

23. A method according to claim 22 wherein the sample containers are all part of a contiguous sample array and wherein the positioning apparatus is capable of moving the sample array so as to sequentially position the sample containers relative to the x-ray source and x-ray detector to allow sequential examination of the sample containers.

24. A method according to claim 19 wherein the crystal growth medium comprises a biological sample.

25. A method according to claim 19 wherein the crystal growth medium comprises a vapor diffusion chamber.

26. A method according to claim 19 wherein the x-ray detector is a two-dimensional detector.

27. A method according to claim 26 wherein the x-ray source and x-ray detector are positioned such as to provide simultaneous exposure and detection across a two-dimensional area of the sample container.

28. A method according to claim 19 further comprising controlling exposure of the sample container by the x-ray source and collection of data from the x-ray detector with a control apparatus.

29. A method according to claim 28 positioning the sample container relative to the x-ray source and the x-ray detector with a positioning apparatus, movement of the sample container with the positioning apparatus being controlled by the control apparatus.

30. A method according to claim 19 wherein the x-ray source and detector operate in reflection mode.

31. A method according to claim 19 wherein the x-ray source and detector operate in transmission mode.

32. A method according to claim 19 further comprising positioning the sample container relative to the x-ray source and the x-ray detector with a positioning apparatus, the positioning apparatus being arranged such that no obstruction exists between the x-ray source and the sample container.

33. A method of monitoring crystal formation in a biological crystal growth medium within a sample container, the method comprising:
directing x-ray energy to the sample container with an x-ray source, the x-ray energy being incident across an area of the sample container undergoing diffraction in the presence of a crystal structure in the sample container;
receiving x-ray energy diffracted from said crystal structure with a two-dimensional x-ray detector and providing a signal indicative of the presence of the crystal structure in the sample container; and
positioning the sample container relative to the x-ray source and the x-ray detector with a positioning apparatus, the positioning apparatus comprising a support that is movable in at least two dimensions.

34. A method according to claim 33 wherein the sample container is a first sample container and wherein the method further comprises sequentially directing x-ray energy to each of a plurality of sample containers each representing a separate growing medium and each being part of a contiguous sample array, receiving any diffracted x-ray energy from each sample container and providing a signal indicative of the presence of any crystal structures in the sample containers, the positioning apparatus being capable of moving the sample array so as to sequentially position the sample containers relative to the x-ray source and x-ray detector to allow sequential examination of the sample containers.

35. A method according to claim 33 wherein the crystal growth medium comprises a vapor diffusion chamber.

36. A method according to claim 33 further comprising controlling the exposure of the sample container by the x-ray source and the collection of data from the x-ray detector with a control apparatus that controls the positioning apparatus for positioning the sample container relative to the x-ray source and the x-ray detector.

37. A method of determining the presence or absence of a crystal structure in a crystal growth medium from which x-ray energy diffracted by the crystal structure is detected with a two-dimensional x-ray detector having a predetermined pixel array, the diffracted x-ray energy having a significantly higher intensity than background x-ray radiation, the method comprising:
establishing a minimum pixel intensity level indicative of the presence of crystallization in the growth medium;
determining the number of pixels having an intensity level exceeding the minimum pixel intensity level; and
comparing the determined number of pixels having an intensity level exceeding the minimum pixel intensity level to a predetermined number of pixels selected as being indicative of the presence of said crystal structure.

38. A method of determining the presence or absence of a crystal structure in a crystal growth medium from which x-ray energy diffracted by the crystal structure is detected with a two-dimensional x-ray detector having a predetermined pixel array, the diffracted x-ray energy having a significantly higher intensity than background x-ray radiation, the method comprising:
identifying the intensity levels of a predetermined number of the pixels having the highest intensity levels and averaging those intensity levels to determine a high intensity average value;
averaging the intensity levels of all of the detector pixels to determine an overall intensity average value;
comparing a ratio of the high intensity average value and the overall intensity average value to a predetermined ratio selected as being indicative of the presence of said crystal structure.

39. A method of determining the presence or absence of a crystal structure in a crystal growth medium from which x-ray energy diffracted by the crystal structure is detected with a two-dimensional x-ray detector having a predetermined pixel array, the diffracted x-ray energy having a significantly higher intensity than background x-ray radiation, the method comprising:
identifying pixel intensity values that are indicative of the presence of a crystal peak in the detected spectrum and integrating those pixel intensity values over the number of pixels producing them to determine a crystal peak integrated intensity;
integrating the intensity values for all of the detector pixels over the total number of detector pixels to determine a total integrated intensity; and
comparing a ratio of the crystal peak integrated intensity and the total integrated intensity to a predetermined ratio selected as being indicative of the presence of said crystal structure.
